(19) United States
(12) Patent Application Publication
(10) Pub. No.: US 2014/0311766 A1
(43) Pub. Date: Oct. 23, 2014

(54) WIRE SECURITY DEVICE AND METHOD FOR PROTECTING A WIRE IN A CONDUIT

(71) Applicant: Heydt Innovations Inc., Middle Village, NY (US)

(72) Inventors: Hans Peter MADER, Middle Village, NY (US); Aloysius GROGAN, Middle Village, NY (US)

(73) Assignee: Heydt Innovations Inc., Middle Village, NY (US)

(21) Appl. No.: 14/094,038

(22) Filed: Dec. 2, 2013

Related U.S. Application Data
(60) Provisional application No. 61/731,729, filed on Nov. 30, 2012.

(51) Int. Cl. H02B 1/46

(52) U.S. Cl. CPC H02B 1/46
USPC 174/50

(57) ABSTRACT

A wire security device is provided or the protection of conduit body of a conduit for a wire. Also provided is a method of enclosing a conduit body with a wire security device such that only authorized persons can unlock the wire security device and access the conduit body.

### CROSS-REFERENCE TO RELATED APPLICATION

The present application claims priority to U.S. Provisional Patent Application Ser. No. 61/731,729 entitled: WIRE SECURITY DEVICE AND METHOD FOR PROTECTING A WIRE IN A CONDUIT, filed on Nov. 30, 2012, the entirety of which is incorporated by reference herein.

### BACKGROUND OF THE INVENTION

Thievery of wire from conduits is costly. For example, ring ground protects buildings and equipment electrical surges, for example as can be caused by lightning strikes. Ring grounds are very commonly used around communications equipment such as cell phone towers, police radio towers, and other types of radio towers and equipment buildings. They are also often used to protect computer data centers. The ring ground will usually encircle a building that it is trying to protect. The ring ground comprises a conduit which includes grounding wire, such as copper wire, encircles the building. Positioned at points along the conduit are conduit bodies or “pull boxes.” Conduit bodies are used, inter alia, to connect threaded conduits when the electrical raceway changes directions. Conduit bodies typically include covers that create a water tight seal and allow easy access for additional wire pulling, inspection and general maintenance. Conduit Bodies can accommodate pipe sizes from ½″ to 4″ in diameter and can be made from malleable iron or die cast aluminum. However, these conduit bodies and conduits are often targets for theft of the copper wire, costing companies and insurance companies millions of dollars each year. If the conduit body or conduit can be broken into, the copper wire can be pilled out and stolen in a matter of moments.

Prior solutions to prevent thievery include using foam which is blown into the conduits and which hardens about the wire therein making it difficult to remove. However, this solution has complicates service by authorized technicians when they need to remove the wire for legitimate purposes.

### SUMMARY OF THE INVENTION

According to embodiments, disclosed is a method comprising: providing wire security device to enclose a conduit body of an conduit for a wire, the wire security device being configured to be secured about the conduit body such that access is prevented to the wire; and providing a locking mechanism on the wire security device such that authorized personnel can access the conduit body.

In connection with embodiments, disclosed is a wire security device comprising an enclosure configured to enclose a conduit body of a conduit for a wire; a locking mechanism; and at least one door or cover for access to the conduit body.

### BRIEF DESCRIPTION OF THE DRAWINGS

Embodiments of the invention are illustrated in the figures of the accompanying drawings, which are meant to be exemplary and not limiting, and in which like references are intended to refer to like or corresponding things.

FIG. 1 shows an illustrative embodiment of a wiring system 10.

FIGS. 2A-2E show an exemplary illustration of a wire security device.

FIGS. 3A-3C show an exemplary illustration of a wire security device.

FIGS. 4A-4C show an exemplary illustration of a wire security device.

FIGS. 5A-5C show an exemplary illustration of a wire security device.

FIGS. 6A-6B show an exemplary illustration of a wire security device.

FIG. 7 shows an exemplary illustration of a wire security device.

FIGS. 8A-8B shows an exemplary illustration of a wire security device.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

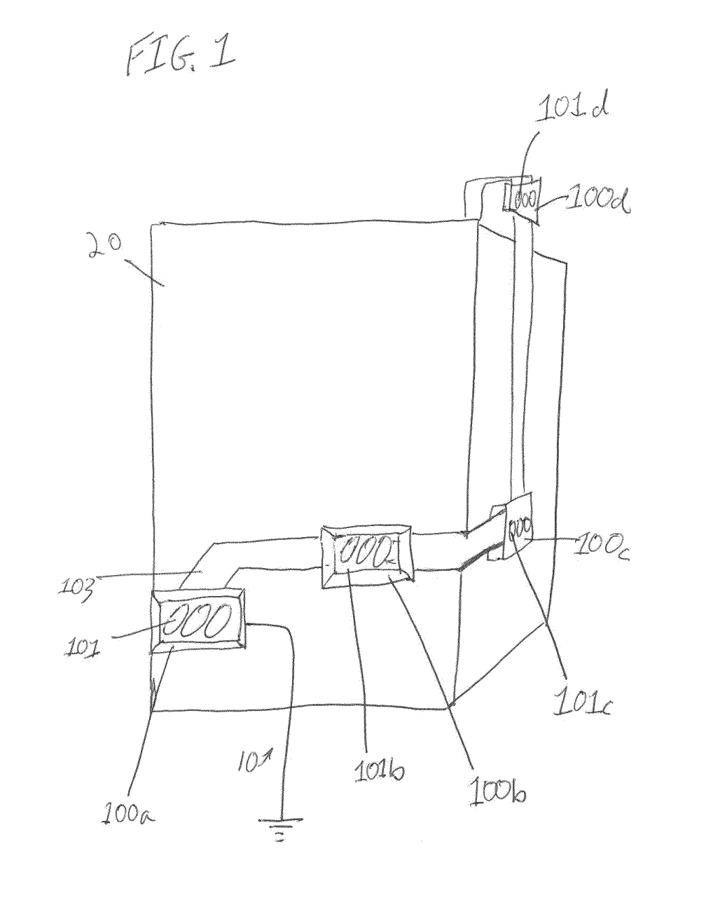

FIG. 1 shows an illustrative embodiment of a wiring system 10, shown as a ring ground. A ring ground protects buildings and equipment electrical surges, for example as can be caused by lightning strikes. Ring grounds are very commonly used around communications equipment such as cell phone towers, police radio towers, and other types of radio towers and equipment buildings. They are also often used to protect computer data centers. The ring ground will usually encircle a building that it is trying to protect, as for example a cell tower. As shown in FIG. 1, a conduit 103 which includes grounding wire (not shown), such as copper wire, encircles the building 20. Positioned at points along the conduit are access points including at least one conduit body 101a, 101b, 101c, 101d for gaining access to the grounding wire (e.g. for service or status checks on the wire). The conduit and wire runs from the roof of the building 20 down the side of the building, and then runs parallel along the building and enters the inside at the location conduit body 101a, where it runs to ground inside. Access to the wire can be gained at conduit bodies 101a, 101b, and 101c on the side of the building and a conduit body 101d on the roof. As shown in FIG. 1, each conduit body is protected with a wire security device 100a, 100b, 100c, 100d.

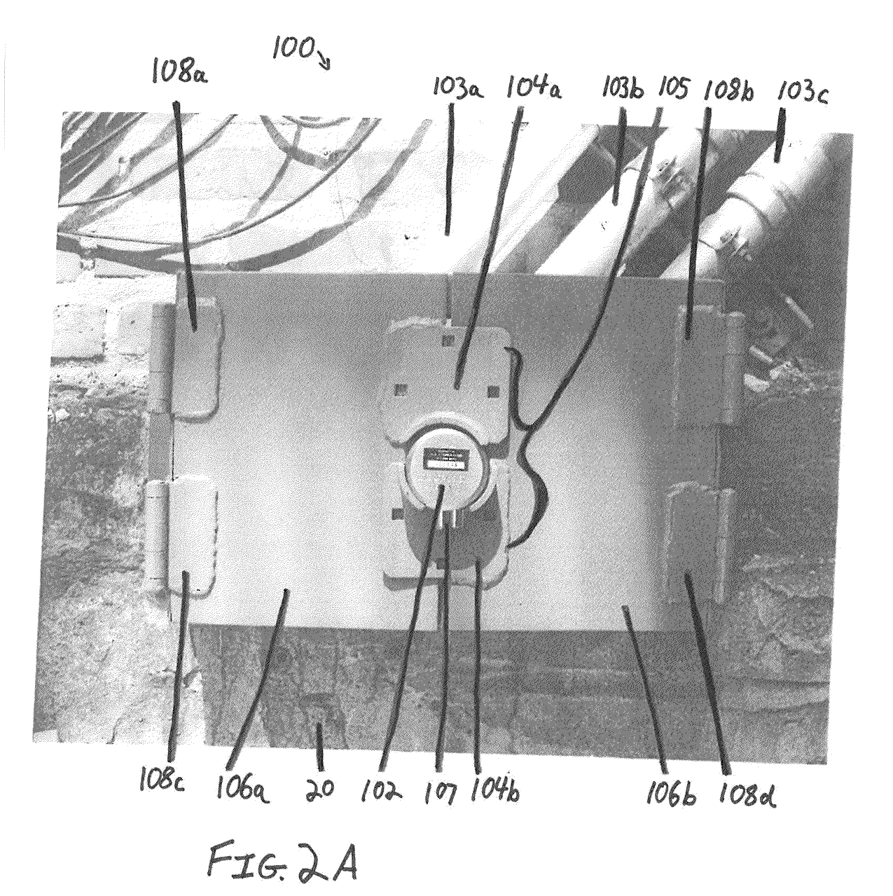

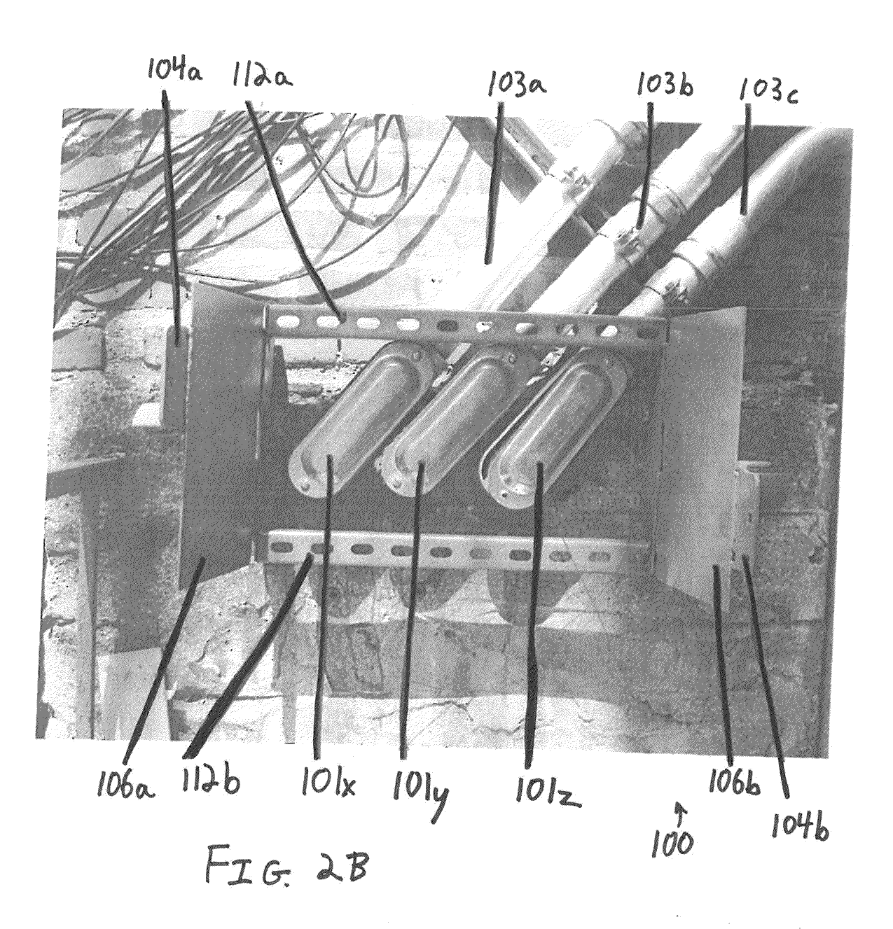

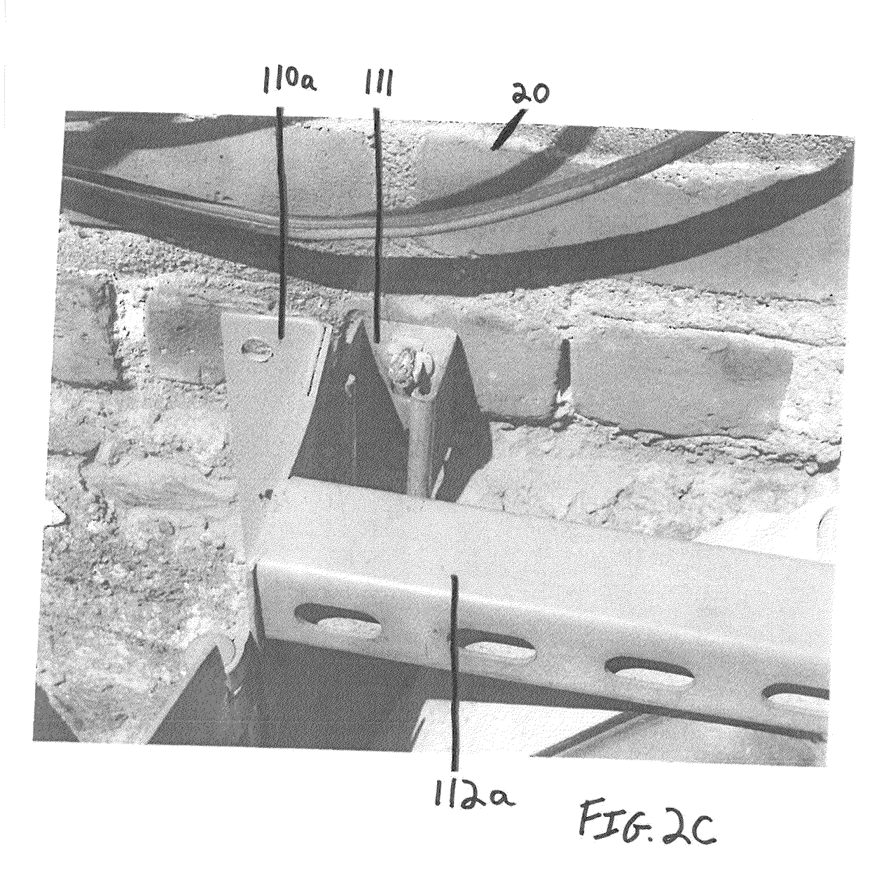

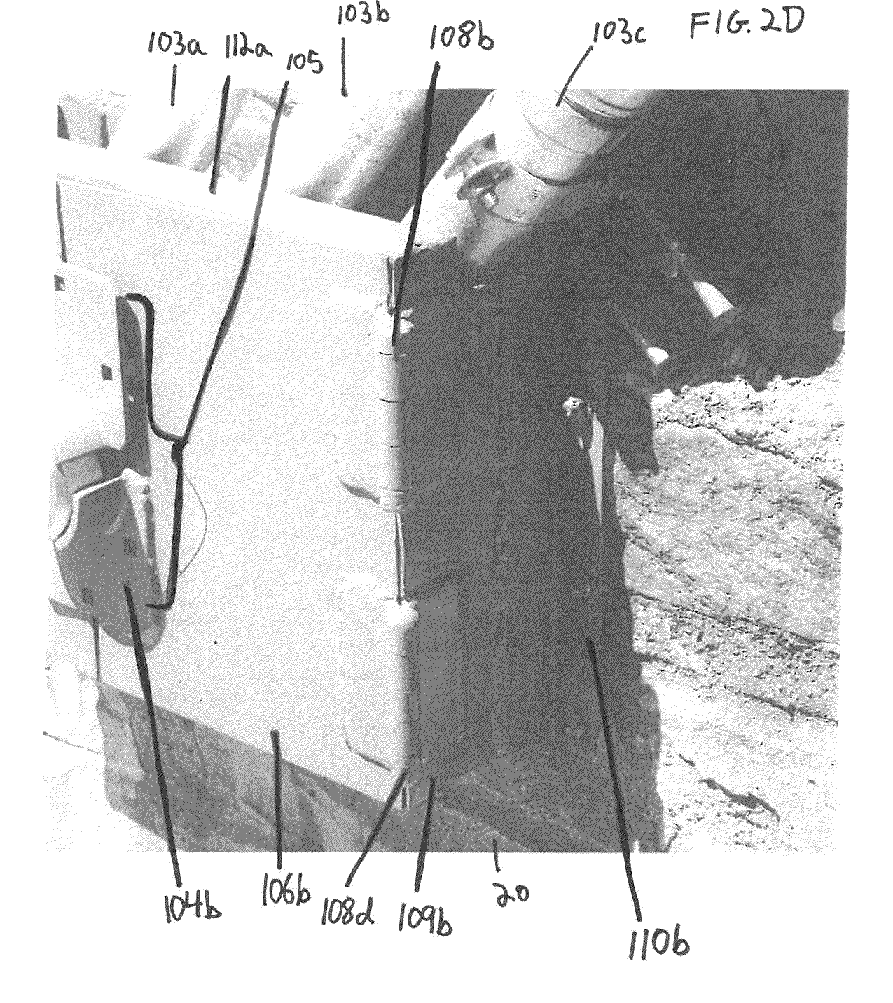

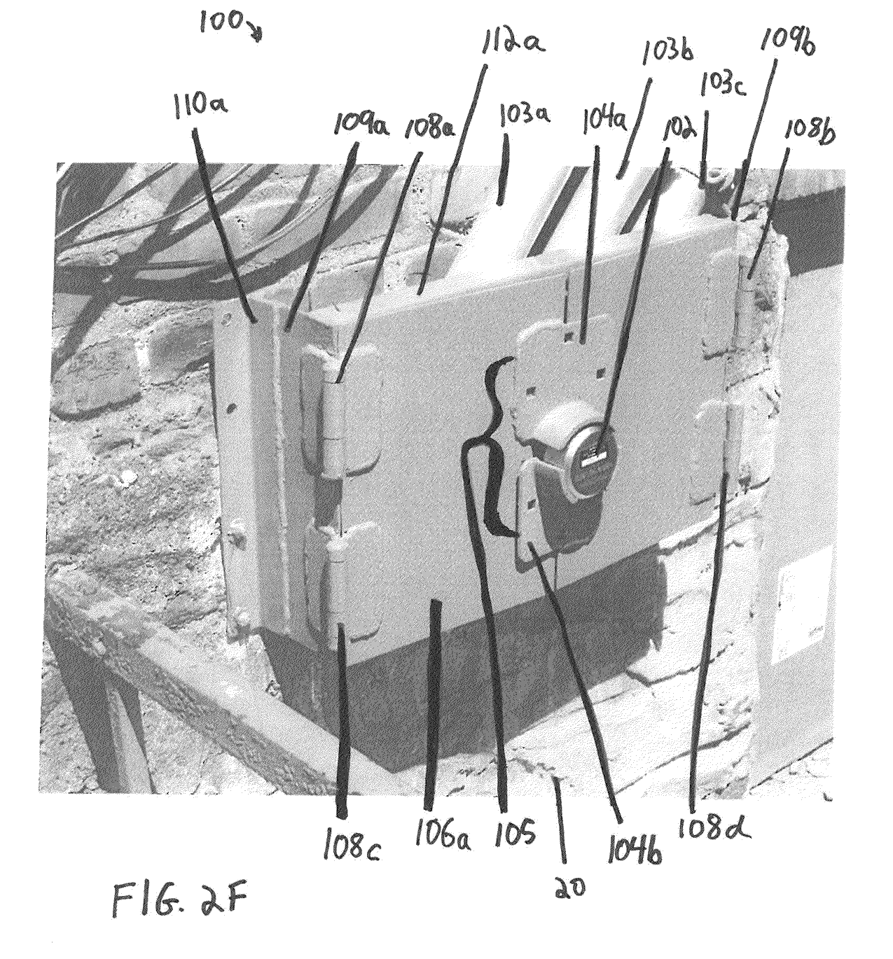

FIGS. 2A-2E show views of an illustrative embodiment of a wire security device 100. The device 100 is configured to allow an authorized individual to readily access and service the wiring system while protecting and deterring unauthorized access. As shown therein, three conduits 103a, 103b, 103c containing wire (not shown) are shown running at an oblique angle into three pull-boxes 101x, 101y, 101z, as shown in FIG. 2B. In FIG. 2A the conduit bodies 101x, 101y, 101z are protected by the wire security device. The device comprises an encasement made of a substantially impregnable material, such as ⅛″ steel. As used herein, substantially impregnable means that the material comprises security grade materials that cannot broken or compromised except by the use of powerful tools or means or require a substantial amount of time to compromise, as it will be understood that no material is indestructible. It will also be understood that less impregnable materials may be used, as for example in highly trafficked areas where a sufficient deterrent is provided by the mere presence of the encasement, or where much less time is needed for the encasement to have a deterrent effect (e.g. in highly trafficked areas or in conjunction with other security devices), and thus less durable materials can be used.

The encasement is operatively attached to the conduit bodies 101x, 101y, 101z such that the wire security device 100 protect the covers of the conduit bodies and hence protects the access point to the wire. The wire security device comprises a locking mechanism 105 to secure the conduit bodies 101x, 101y, 101z. As shown, the lock is a hockey puck type lock 102 and lock hasp 104. As shown, an exemplary hasp is a Master™ lock hasp 104 comprising two hasp components 104a, 104b forming an upper hasp component 104a and lower hasp component 104b for the lock 102, however as will be understood, any locking mechanisms known in the art can be employed for each of the embodiments as described herein.

The encasement of the wiring security device comprises an access door or cover 106a, 106b which can be opened to access the conduit bodies 101x, 101y, 101z. As shown in the illustrative embodiment, the access door or cover comprises two doors 106a, 106b with the locking mechanism 105 securely connected in the center. The doors 106a, 106b are made of ⅛″ steel strips. The upper and lower hasp components 104a, 104b are each welded to a door 106a, 106b. As shown, the upper hasp component 104a is welded to the left-facing door component 106a and the lower hasp component is welded to the right-facing door component 106b. As such, when a bolt or lock 107 of the locking mechanism is disengaged, the doors 106a, 106b can be opened.

At the outside edges of each door 106, 106b are a plurality of hinges 108a, 108b, 108c, 108d, shown as four hinges 108a, 108b, 108c, 108d, two hinges 108a, 108c for the left side door 106a, and two hinges 108b, 108d for the right side door 106b. As will be appreciated, the number and configuration of the hinges can change depending on the configuration of the encasement.

The wire security device 100 configured and positioned to prevent access to a conduit body 101 to anyone who cannot disengage the lock. In the illustrative embodiment shown in FIGS. 2A-2E, the wire security device 100 is not fastened directly to the conduit bodies 101x, 101y, 101z, but instead is bolted into the face of the building 20 such that the encasement and doors block access. Accordingly, an upper connector 112a and base connector 112b are positioned above and below the conduit bodies 101x, 101y, 101z, here shown as a pair of ¾″ kindorfs. As shown in the FIGS. 2A-2F, the connectors are connected to the building 20 such that they allow the conduits 103x, 103y, 103z access to the conduit bodies 101x, 101y, 101z but otherwise restrict access to the conduit bodies.

For example, as shown in FIG. 2B, the upper connector 112a is positioned to lay on the top surface of conduit bodies 101x, 101y, 101z and against the conduits 103x, 103y, 103z. The doors 106a, 106b are connected side plates 109a, 109b, connected at each side of the connectors 112a, 112b, so as to form the left and right sides of the wire security device and thereby encase and block lateral access to the conduit bodies 101x, 101y, 101z. The left side door 106a is connected to the side plate 109a by left side hinges 108a and 108c, and the right side door 106b is connected to the right side plate 109b by right side hinges 108b, 108d. As shown in the FIGS. 2A-2E, the connections are made by welding, however other secure forms of connection or fabrication as known in the art can be employed. The enclosure of the wire security device 100 is such that when the doors 106a, 106b are closed, the inside panels of the doors 106a,106b touch or nearly touch the surface covers of the conduit bodies 101x, 101y, 101z. As such, when locked the conduit bodies 101x, 101y, 101z cannot be accessed except by unlocking the doors.

In the illustrative embodiment, a mounting device 110 is provided to securely mount the wire security device 100 to the face of the building 20. As shown in FIGS. 2C-2E, the mounting device includes a left side L shaped bracket 110a and right side L shaped bracket 110b. The right and left side plates 109a, 109b are each welded along longitudinal surfaces of the respective right and left side brackets 110a, 110b. The 90 degree bases of the brackets 110a, 110b are then bolted to the building 20, and the bolts welded thereafter for added security. Internal brackets 111 can also be provided, which are welded to either the interior face of the side plates 109, the connectors 112 or both. As shown in FIG. 2C, a left internal bracket 111a is be welded to the interior face of the left side plate 109a, and inside of the upper connector 112a. The internal bracket is bolted to the face of the building 20, thereby adding a more secure mounting as well as further preventing access to the mounting to the face of the building when the doors 106a, 106b are locked.

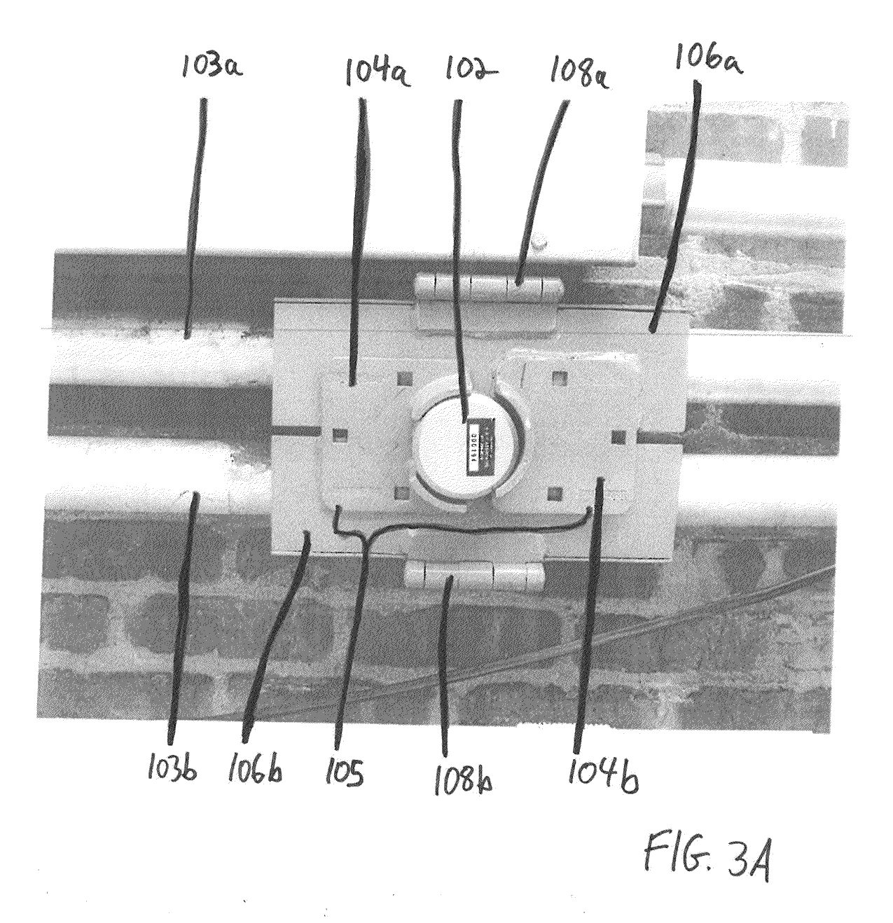

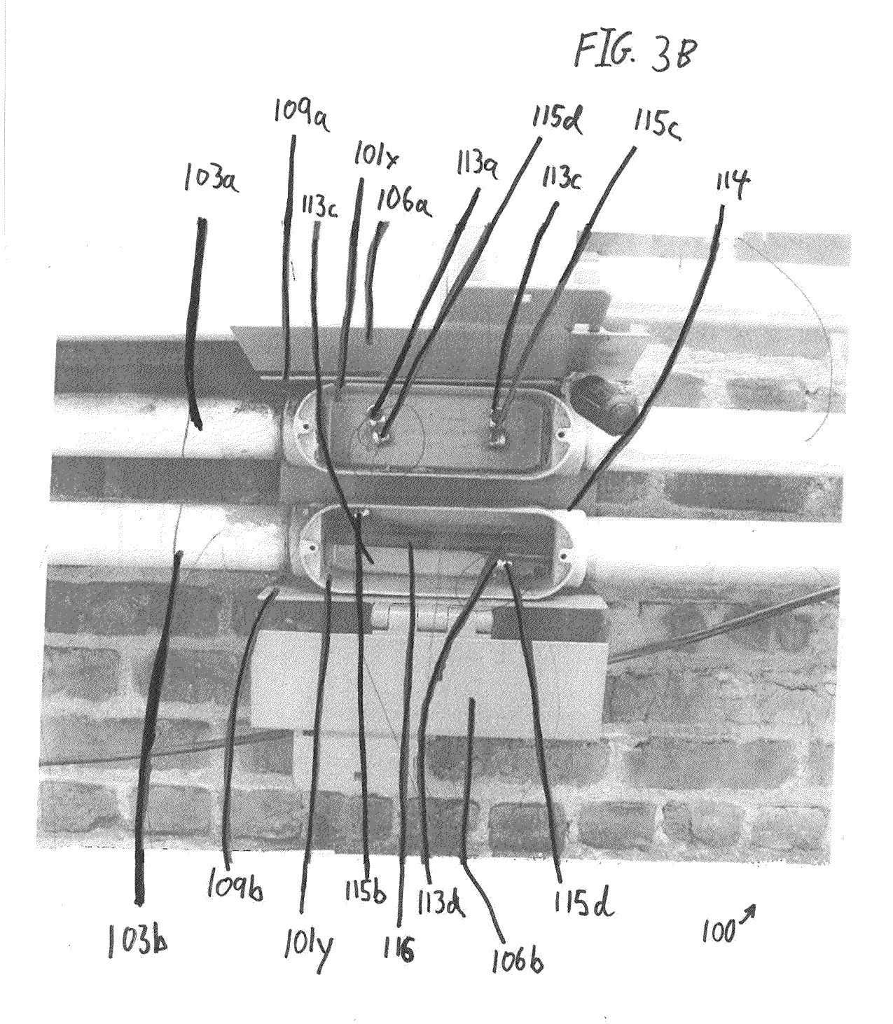

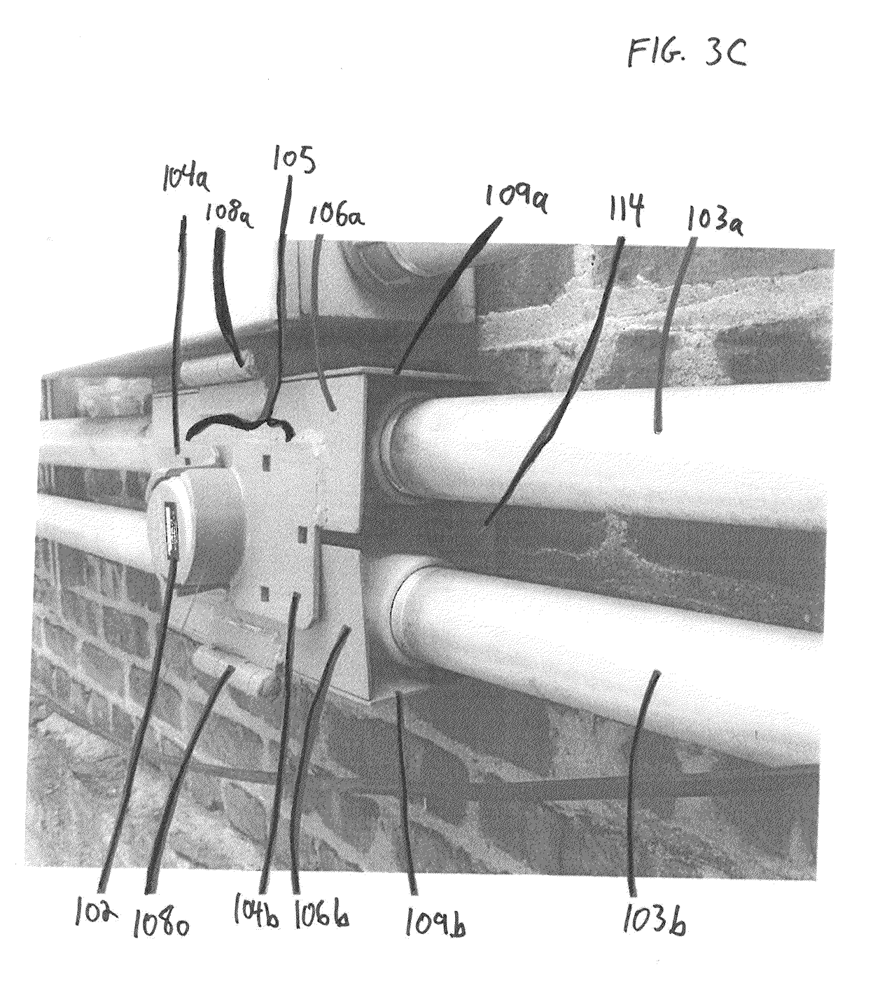

FIGS. 3A-3C show views of another illustrative embodiment of a wire security device 100. As shown therein, two conduits 103a, 103b containing wire 116 are shown running laterally along the face of a building. Two conduit bodies 101x, 101y are shown in FIG. 3B. In FIG. 3A the conduit bodies 101x, 101y are protected by the wire security device 100. The device 100 comprises an encasement made of a substantially impregnable material, such as ⅛″ steel.

The encasement is operatively attached to the conduit bodies 101x, 101y such that the wire security device 100 protects the conduit bodies' 101x, 101y covers and hence covers the access point to the wire. The wire security device 100 comprises a locking mechanism 105 to secure the conduit bodies 101x, 101y. As shown, the lock is a hockey puck type lock 102 and lock hasp 104. As shown, an exemplary hasp is a Master™ lock hasp 104 comprising two hasp components 104a, 104b positioned laterally in the direction of the conduits 103a, 103b, shown as a left side hasp component 104a and a right side hasp component 104b for the lock 102, however as will be understood other such hasps and/or locking configurations can be employed.

The encasement of the wiring security device comprises an access door or cover 106a, 106b which can be opened to access the conduit bodies 101x, 101y. As shown in the illustrative embodiment, the access door or cover comprises two doors 106a, 106b with the locking mechanism 105 securely connected in the center. The doors 106a, 106b are made of ⅛″ steel strips. The upper and lower hasp components 104a, 104b are each welded to a door 106a, 106b. As shown, the left-side hasp component 104a is welded to a bottom door component 106a and the lower hasp component is welded to an upper door component. As such, when a bolt (not shown) of the locking mechanism disengaged, the doors 106a, 106b can be opened.

At the outside edges of each door 106a, 106b are a plurality of hinges 108a, 108b shown as two hinges 108a, 108b one hinge 108a for the upper door 106a, and one hinge 108b for the bottom door 106b. As will be appreciated, the number and configuration of the hinges can change depending on the configuration of the encasement.

As shown in FIGS. 3A-3C, the doors 106a, 106b are connected upper and lower plates 109a, 109b, so as to form the bottom and top sides of the wire security device 100 and thereby encase and block vertical access to the conduit bodies 101x, 101y. The upper side door 106a is connected to the upper plate 109a by upper hinges 108a, and the lower door 106b is connected to the bottom side plate 109b by the lower hinge 108b. The upper and lower plates 109a, 109b are respectively welded to the top and bottom of the back side plate 114, which in turn is fastened to one or more conduit bodies 101a, 101b as described below, thereby completing the enclosure around the conduits 103a, 103b. As shown in the FIGS. 3A-3C, the connections are made by welding, however other secure forms of connection or fabrication as known in the art can be employed. The enclosure of the wire security device 100 is such that when the doors 106a,106b are closed, the inside panels of the doors 106a,106b touch or nearly touch the surface covers of the conduit bodies 101x, 101y. As such, when locked the conduit bodies 101x, 101y cannot be accessed except by unlocking the doors.

The wire security device 100 is connected to the conduit body 101. For example, in an illustrative embodiment, the wire security device 100 is connected directly to at least one of the conduit bodies 101a, 101b by drilling a hole in the interior back-side of the conduit body 101x and a back plate 114 of wire security device 100. The holes through each are then threaded and attached with fasteners 113a, 113c, such as for example 5/16″ to 24×½″ button heads screw holo-krome. As shown in FIG. 3B, four holes are drilled through the conduit bodies 101x, 101y and the back plate 114, two for the upper conduit body 101a and two for the lower conduit body 101b, allowing for 4 fasteners 113a, 113b, 113c, 113d. The conduit bodies 101x, 101y positioned along a perpendicular axis at an access point for the two conduits 103a, 103b running in parallel. As will be appreciated the wire security device 100 could be connected to one of two conduit bodies 101x, 101y as the encasement provided by the wire security device 100 would still prevent access to both conduit bodies 101x, 101y as the wire security device still encloses both conduit bodies and 101x, 101y would be securely fastened about them and the conduits 103a,103b.

The wire security device can also comprise wire holders 115a, 115b, 115c, 115d configured to hold and secure the wire inside the conduit body 101. As shown in FIG. 3B, each conduit body 101x,101y is provided with two of the internal wire holders 115a, 115b, 115c, 115d which are bolted to the conduit body 101x, 101y where the bolts secure the conduit body to the back plate 114. The wire 116 can be fastened to the wire holder, for example by using a plastic zip tie. This prevents theft of the wire by someone attempting to circumvent the wire security device 100 by attempting to gain access by through the conduit (e.g. cutting open the conduit) as opposed to via the protected conduit body 101. If the conduit 103 is compromised, the wire 116 would still be secured in place inside the conduit body, and thus it could not be pulled free from the conduit 103. As will be appreciated, this provides even greater security if done at every conduit body along the conduit.

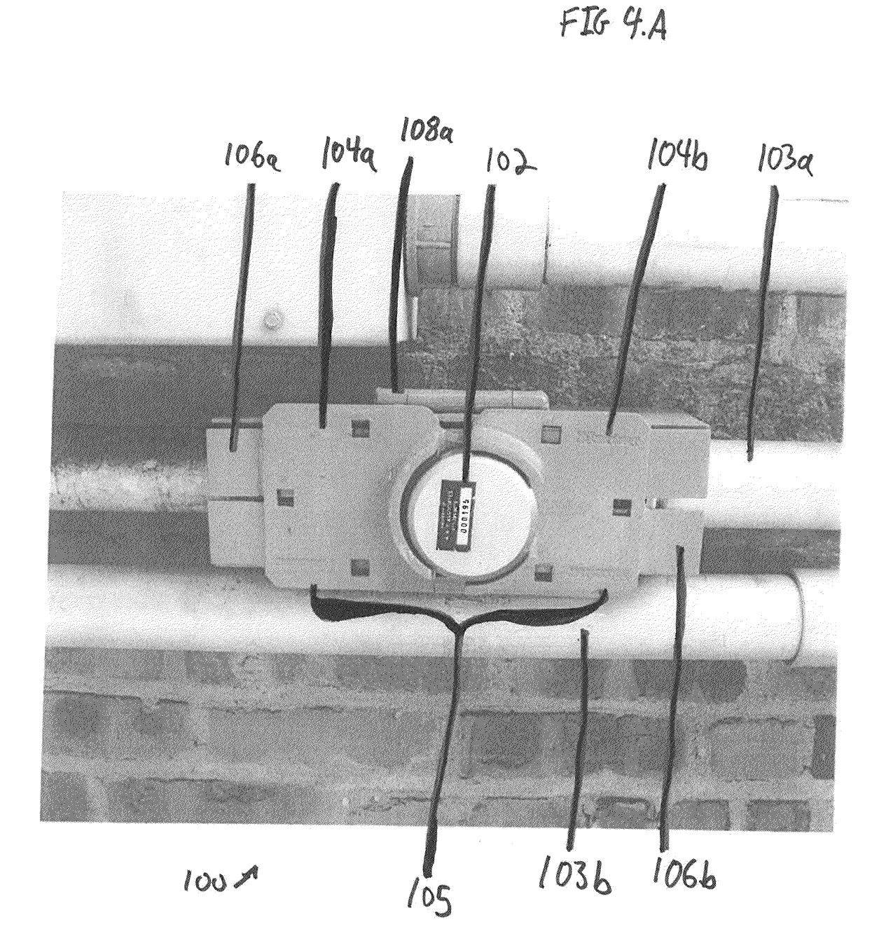

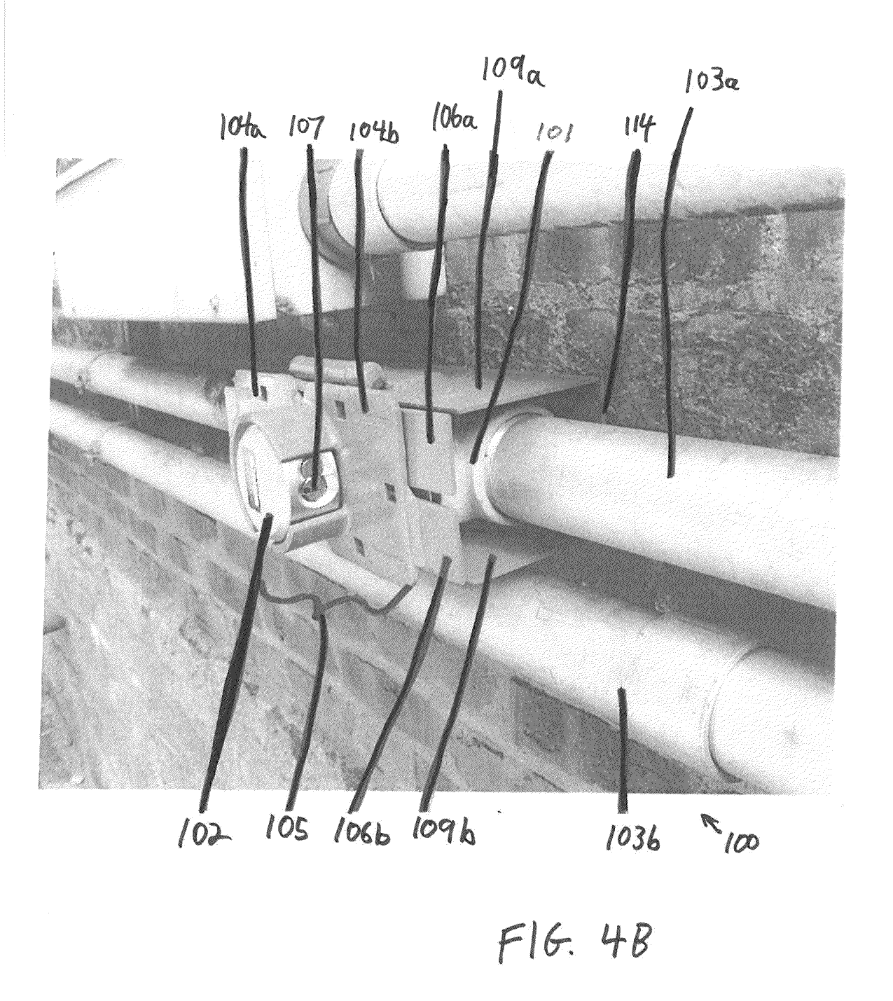

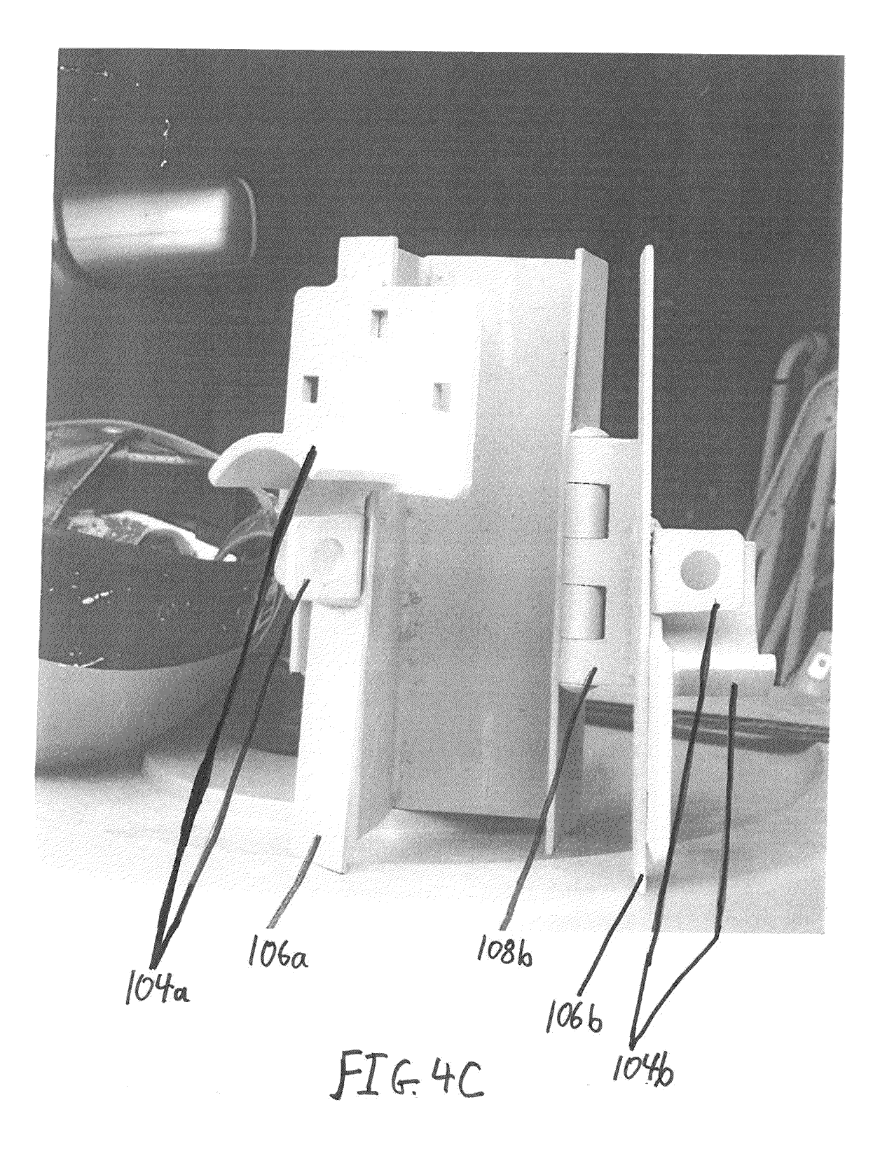

FIGS. 4A-4C show views of another illustrative embodiment of a wire security device 100. Similar to the embodiment of FIGS. 3A-3C, two conduits 103 containing wire (not shown) are shown running laterally along the face of a building. However, only one conduit body 101 is shown in FIGS. 4A-4B. The conduit body 101 is protected by the wire security device 100, which is configured similarly to that of FIGS. 3A-3F, except that the wire security device only encloses and is secured to one conduit body 101 and conduit 103a and the dimensions of the doors 106a, 106b and back plate 114 shortened along the direction perpendicular to the conduit 103a accordingly.

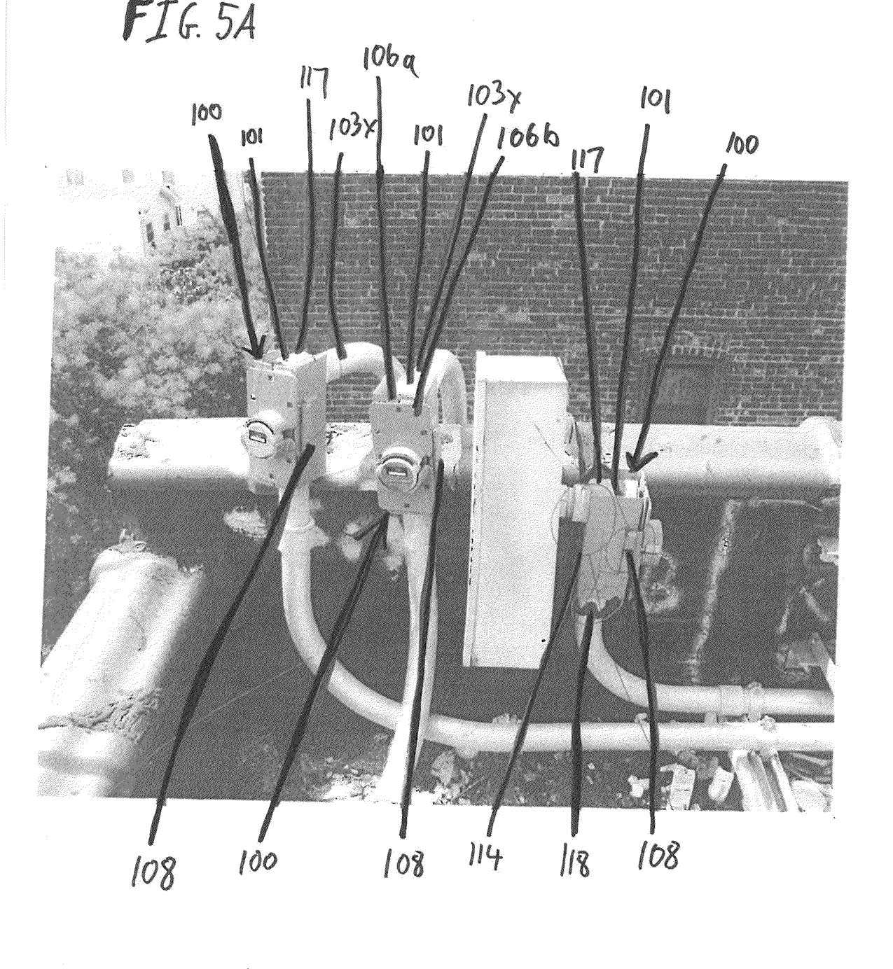

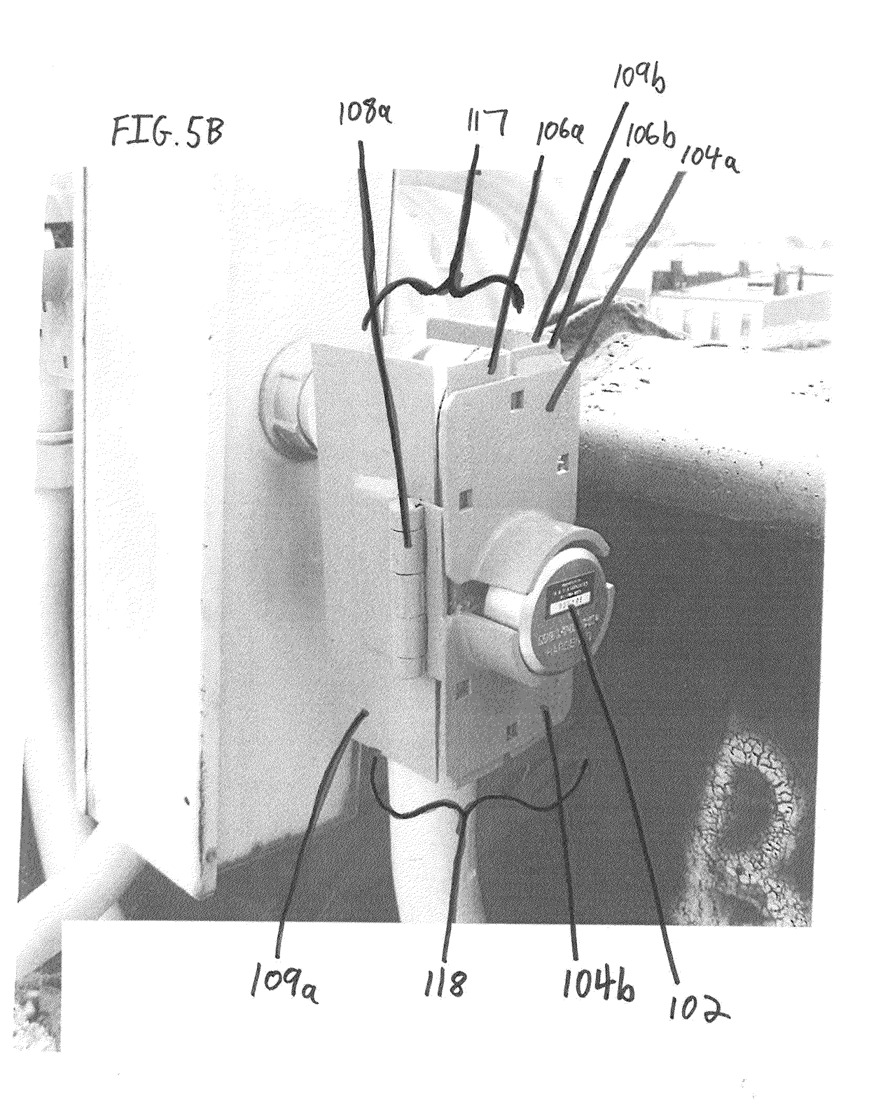

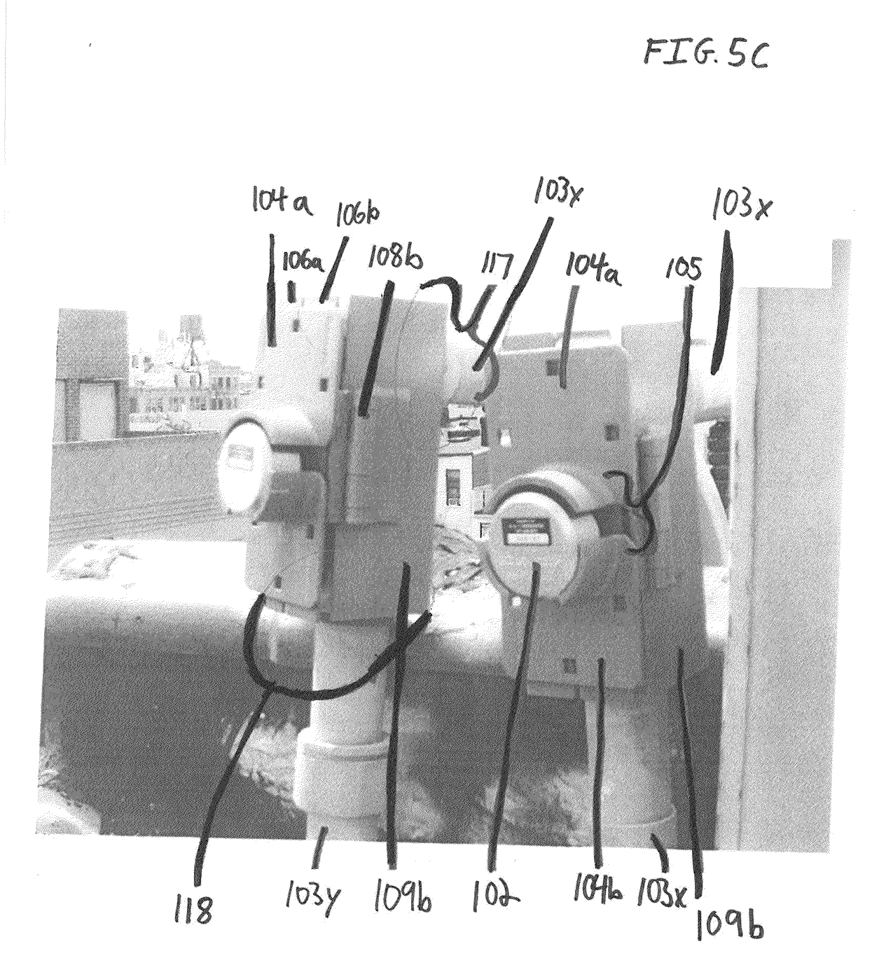

FIGS. 5A-5C show views of another illustrative embodiment of a wire security device 100. Similar to the embodiment of FIGS. 4A and 4B a single conduit body 101 is protected by the wire security device 100, and the wire security device only encloses and is secured to one conduit body 101 and conduit 103 and the dimensions of the doors 106a, 106b and back plate 114 are configured accordingly. The wire security device 100 is further configured as an “angle-box,” and is configured to protect a conduit body 101 that provides and access point located at an elbow joint configuration for the conduit 103. Such conduit configurations can be found, for example, on the roofs of buildings having a ring ground. As such, the back plate 114 is formed such that there is an opening 117 for a conduit 103x to enter the back side of the wire security device 100 at an orientation substantially perpendicular to the wire security device 100, and a conduit 103y to laterally enter the wire security device at an opposite end, shown as a vertical entry 118 as shown in the FIGS. 5A-5C.

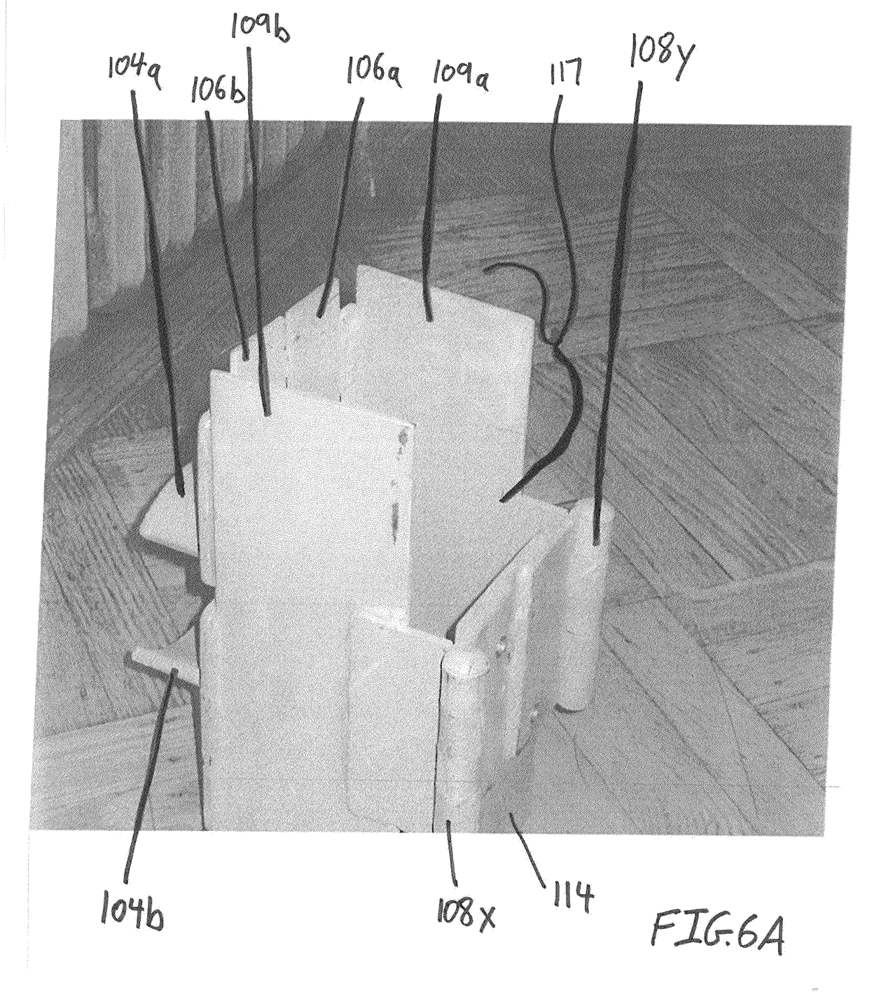

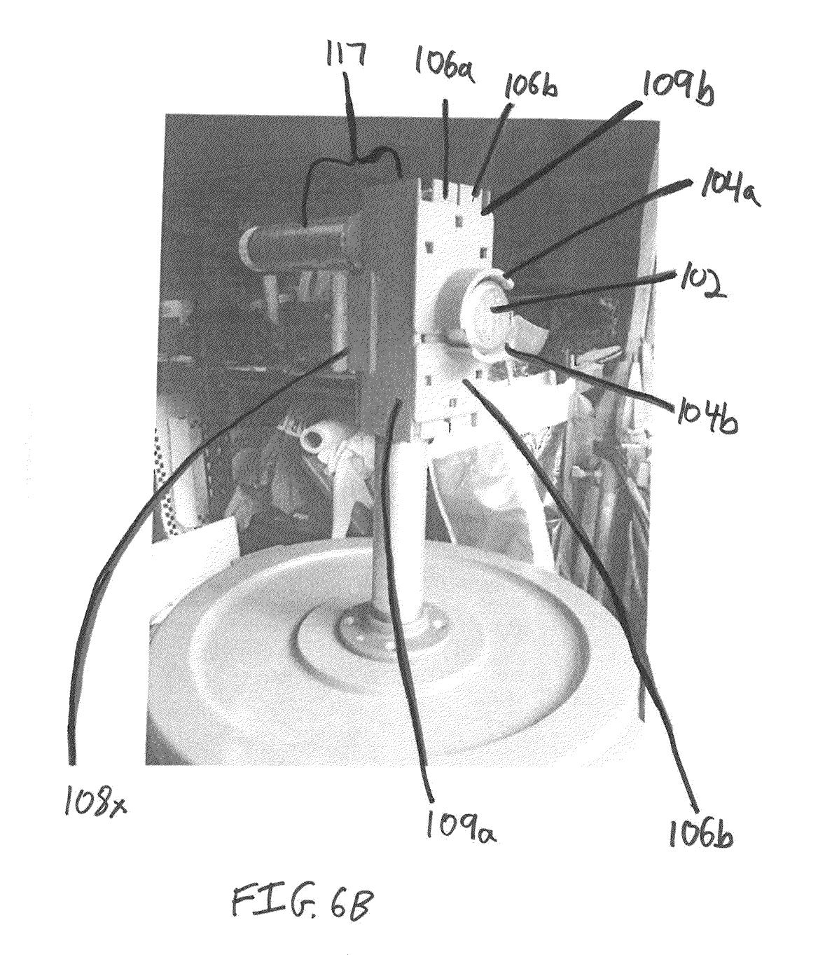

FIGS. 6A-6B show views of another illustrative embodiment of a wire security device 100. Similar to the FIGS. 5A-5C a single conduit body 101 is protected by the wire security device 100, and the wire security device only encloses and is secured to one conduit body 101 and conduit 103 and the dimensions of the doors 106a, 106b and back plate 114 are configured accordingly. The wire security device 100 is again further configured as an “angle-box,” and is configured to protect a conduit body 101 that provides and access point located at an elbow joint configuration for the conduit 103. However illustrative embodiment the hinges are connected at the back of the wire security device 100. As shown in FIG. 6A, at each side of the back plate 114, are two hinges 108x, 108y one hinge at each side of the back plate 114. The side plates 109a, 109b are connected to the hinges 108x, 108y of the wire security device 100 and thereby encase and access to a conduit body 101. The side plates 109a, 109b respectively welded to doors 106a,106b, which are provided with a locking mechanism 105 comprising a lock 102 and hasp as described herein. As such, the enclosure forms a sleeve about the elbow which opens and closes from the hinges 108x, 108y at the back of the wire security device such that the sides 109a, 109b and front doors 106a,106b rotate outward when opening. As will be noted, the conduit body 101 can be fastened to the back plate 114 and plate of the hinges 108x, 108y welded thereto by drilling a hole through the conduit body, back plate 114 and hinge 108x, 108y plates.

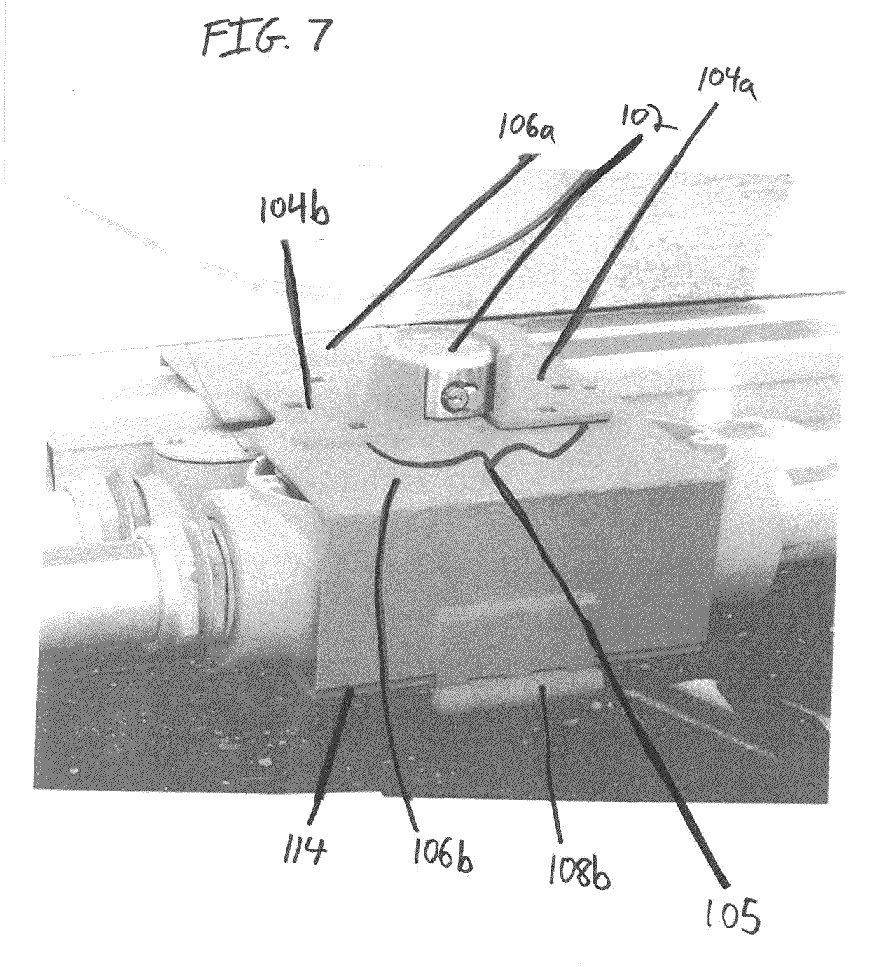

FIG. 7 shows views of another illustrative embodiment of a wire security device 100 similar to that of FIGS. 3A-3C. As shown therein, two conduits 103 containing wire 116 are shown running laterally along the face of a building. The encasement is operatively attached to the conduit bodies 101x, 101y such that the wire security device 100 protects the conduit bodies' 101x, 101y covers and hence covers the access point to the wire. However the hinges 108a (not shown), 108b rather than being connected to the door or covers 106a, 106b, are connected to a back plate 114 of the wire security device 100. Also, as will be noted, the doors 106a, 106b do not entirely cover the conduit bodies 101x,101y, as a portion of the conduit bodies 101x,101y protrude from each side of the encasement of the wire security device 100. However the doors 106a, 106b provide sufficient coverage such that when locked, they will prevent access to the wire (not shown).

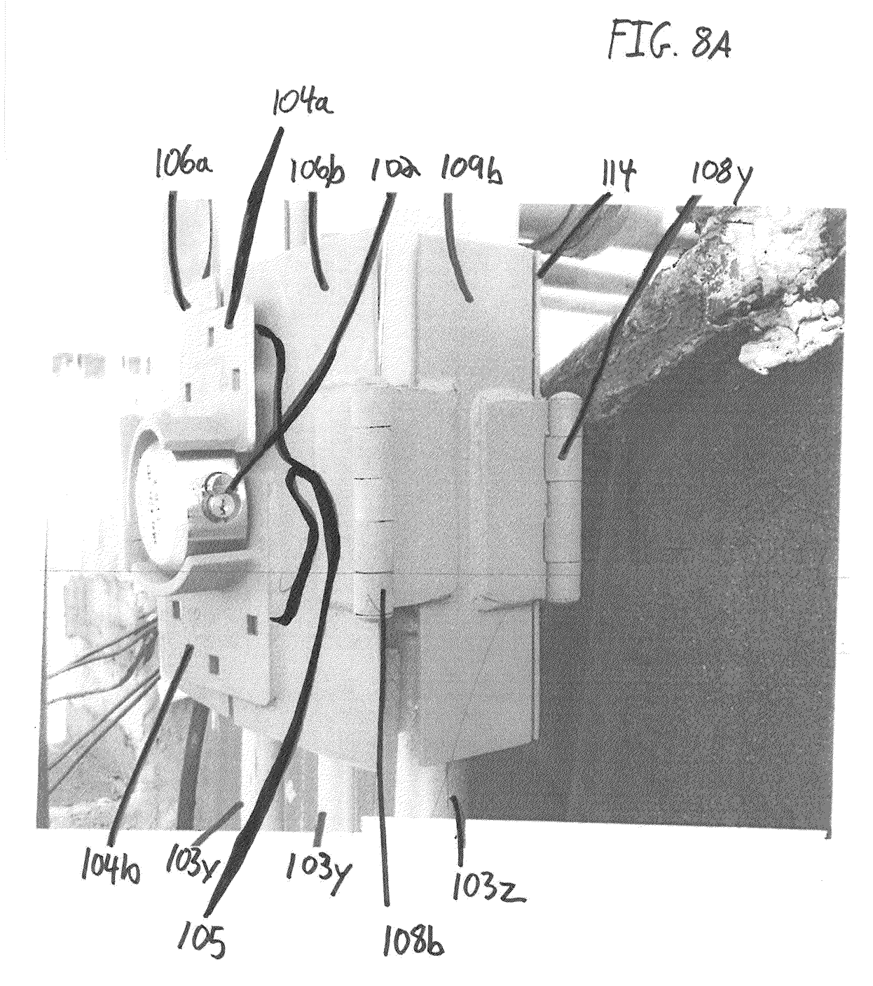

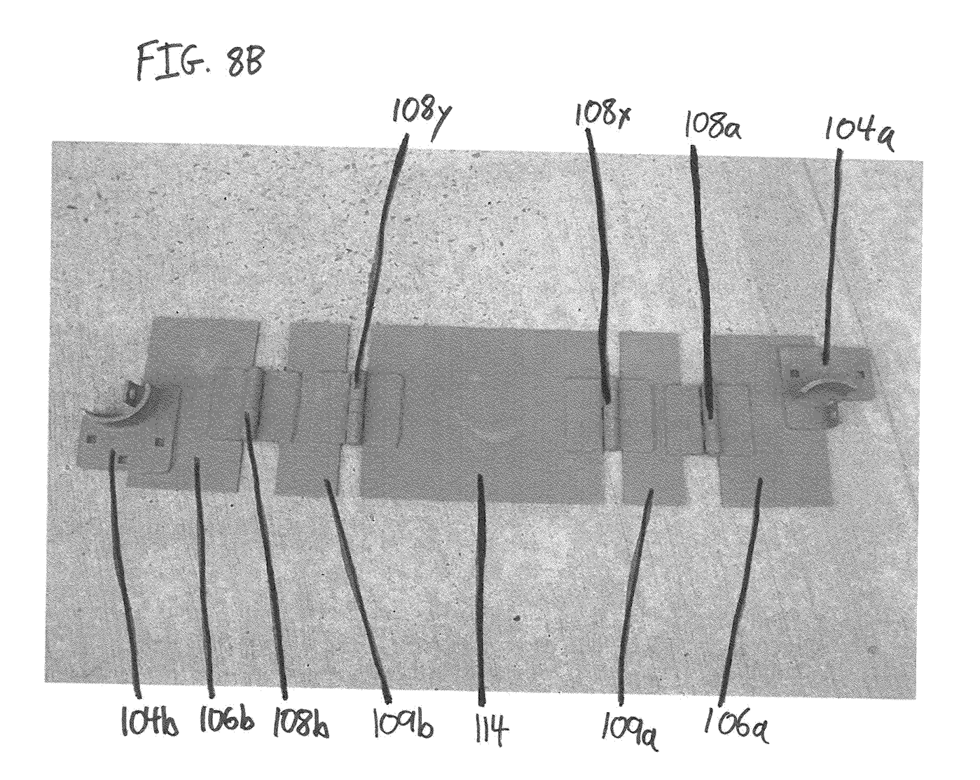

FIG. 8 shows a view of another illustrative embodiment of a wire security device 100 similar to the configuration of FIGS. 3A to 3C. As shown therein, three conduits 103 containing wire are shown running laterally along an irregular portion of a building 20. Three pull-boxes (not shown) are protected by the wire security device 100, similar to the manner in which two conduit bodies are protected in FIGS. 3A-3C, shown in FIG. 8 at a vertical orientation.

The illustrative embodiment of FIGS. 8A-8B also differs from the embodiment of FIGS. 3A-3C in that four hinges 108a, 108b, 108x, 108y are provided on both doors 106a, 106b and the back plate 114. At the outside edges of each door 106a, 106b are a plurality of hinges 108a, 108b; one hinge 108a for the left-side door 106a, and one hinge 108b for the opposite door 106b. At each side of the back plate 114, are another two hinges 108x, 108y one hinge connected at each side of the back plate 114. The door hinge 108b is connected to a the proximate (right) side plate 109b at the front and the back plate 114 is connected to the proximate (right) side of the plate 114 by the back side hinge 108y; the same configuration is provided on the distal (left) side of the wire security device. The doors 106a, 106b are provided with a locking mechanism 105 comprising a lock 102 and hasp 104 as described herein, although as described above, any locking mechanism as know in the art can be used. As shown in FIG. 8B, this configuration allows the wire security device 100 to be unfolded into a substantially flat configuration as there are hinges 108 for each of the plates 106a, 106b, 109a, 109b, 114 forming the encasement. Such a configuration can be used when, for example, to aid an installation of the wire security device in a location where an obstruction requires flattening of the encasement to install the wire security device around one or more conduits.

What is claimed is:

1. A method comprising:
providing a wire security device to enclose a conduit body of an conduit for a wire, the wire security device being configured such that the wire security device can be secured about the conduit body such that access is prevented to the wire; and
providing a locking mechanism on the wire security device such that authorized personnel can access the conduit body.

2. A wire security device comprising:
an enclosure configured to enclose a conduit body of a conduit for a wire;
a locking mechanism; and
at least one door or cover for access to the conduit body.
